(19) United States
(12) Patent Application Publication
(10) Pub. No.: US 2023/0297982 A1
(43) Pub. Date: Sep. 21, 2023

(54) SYSTEMS AND METHODS FOR CREATING AND RETRIEVING A CUSTOMIZED DIGITAL CONTENT ITEM

(71) Applicant: Watch Skins Corporation, San Juan, PR (US)

(72) Inventors: Collin Knock, San Juan, PR (US); Justin Knock, San Juan, PR (US)

(21) Appl. No.: 17/696,281

(22) Filed: Mar. 16, 2022

(51) Int. Cl. G06Q 20/12; G06Q 20/38; G06Q 20/36

(52) U.S. Cl. CPC G06Q 20/1235; G06Q 20/389; G06Q 20/3678; G06Q 2220/00

(57) ABSTRACT

Systems and methods to create a customized digital content item and retrieve the digital content item to be displayed are disclosed. Exemplary implementations may effectuate presentation of a customization interface; receive a mint request to mint the digital content item in accordance with a digital content item design; effectuate a transfer of consideration from a user wallet to an administrative wallet; mint the digital content item; transfer a non-fungible token to the user wallet; receive a display request to display the digital content item on a device; determine whether the user wallet holds a non-fungible token associated with the digital content item; responsive to the user wallet holding the non-fungible token, facilitate display of the digital content item on the device; responsive to the user wallet not holding the non-fungible token, take no action to facilitate display of the digital content item on the device; and/or perform other operations.

### FIELD OF THE DISCLOSURE

The present disclosure relates to creating and/or retrieving a customized digital content item to be displayed, streamed, or otherwise viewed.

### BACKGROUND

Digital content items associated with non-fungible and fungible tokens are known. Distributed ledgers are known techniques to produce a secure record or registry of ownership of assets, transactions, and other information. For example, a distributed blockchain is a distributed ledger. Different types of distributed ledgers are known.

### SUMMARY

One aspect of the present disclosure relates to a system configured to create a customized digital content item that is capable of being displayed (i.e., streamed, viewed, etc.) on a device. The user may select a type of digital content item to customize. The types of digital content items may include an object, an image, a video, an audio, and/or other types of digital content. The user may select one or more digital features to be included in the digital content item. The user may select the digital features with varying styles, formats, colors, and/or other aspects through a customization interface. For example, the user may select a type of digital feature to be included in the customized digital content item. The type of digital features may include supplemental digital objects, backgrounds, effects, text, sounds, widgets, and/or other types of digital features. The values of digital features selected by the user may define a digital content item design that is later used to generate the digital content item. The user may purchase the customized digital content item design by submitting a mint request and transferring the appropriate amount of consideration from a user wallet to an administrative wallet. The transfer of consideration from the user wallet to an administrative wallet may include a transfer of value from an address associated with the user wallet to an address associated with an administrative wallet on a decentralized ledger. Once consideration is received by the administrative wallet, the digital content item capable of being displayed may be minted and the digital content item may contain the values of digital features defined by the digital content item design purchased by the user. A digital content item record may be generated for the minted digital content item and a non-fungible token may be transferred to the address on the decentralized ledger that corresponds to the user wallet. The digital content item record may include information pertaining to the digital features and may include a digital content item identifier that is unique to the digital content item. The non-fungible token may indicate the digital content item identifier, such that holding the non-fungible token indicates ownership of the digital content item associated to the digital content item identifier.

The system is further configured to retrieve the digital content item to be displayed on a device. The device may be associated with the user and/or the user wallet. The system may receive a display request from a user. The display request may indicate the digital content item being requested (e.g., using the digital content item identifier), the user associated with the device, and/or other information. Responsive to receiving the display request, the system may determine whether the user wallet associated with the user holds a non-fungible token associated with the digital content item being requested. Holding the non-fungible token may indicate the non-fungible token is recorded on the decentralized ledger at the address associated with the user wallet. Responsive to determining the user wallet holds the non-fungible token, the system may facilitate transmission of information to the device that causes the device to display the digital content item. Responsive to determining the user wallet does not hold the non-fungible token, the system may take no further action to transmit information to the device.

The system configured to create a digital content item and retrieve the digital content item to be displayed may include one or more of servers, decentralized ledger servers, client computing platforms, external resources, networks, users, user interfaces, and or other components. The one or more servers and/or decentralized ledger servers may include electronic storage, one or more hardware processors, one or more blockchains, and/or other components. The electronic storage may be configured to store information. The one or more hardware processors may be configured to execute one or more computer processing components. The one or more computer processing components may include one or more of a presentation component, a transaction component, a minting component, a receipt component, a verification component, a display component, an input component, a communication component, and/or other components.

As used herein, any association (or relation, or reflection, or indication, or correspondency) involving servers, processors, client computing platforms, users, user accounts, digital content items, digital features, assets, requests, manners of usage, exchanges, challenges, offers, transactions, ownership, decentralized ledgers, responses, denials, contracts, incentives, proposals, sets of instructions, operations, determinations, distributions, transfers, presentations, interfaces, notifications, and/or another entity or object that interacts with any part of the system and/or plays a part in the operation of the system, may be a one-to-one association, a one-to-many association, a many-to-one association, and/or a many-to-many association or “N”-to-“M” association (note that “N” and “M” may be different numbers greater than 1).

As used herein, the term “receive” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any” effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to create a customized digital content item and retrieve the digital content item to be displayed, in accordance with one or more implementations.

FIG. 2 illustrates a method to create a customized digital content item, in accordance with one or more implementations.

FIG. 3 illustrates a method to retrieve a digital content item to be displayed, in accordance with one or more implementations.

FIG. 4. illustrates an exemplary customization interface that may be utilized by a system to create a customized digital content item, in accordance with one or more implementations.

FIG. 5A-B. illustrates an exemplary customization interface that may be utilized by a system to create a customized digital content item, in accordance with one or more implementations.

### DETAILED DESCRIPTION

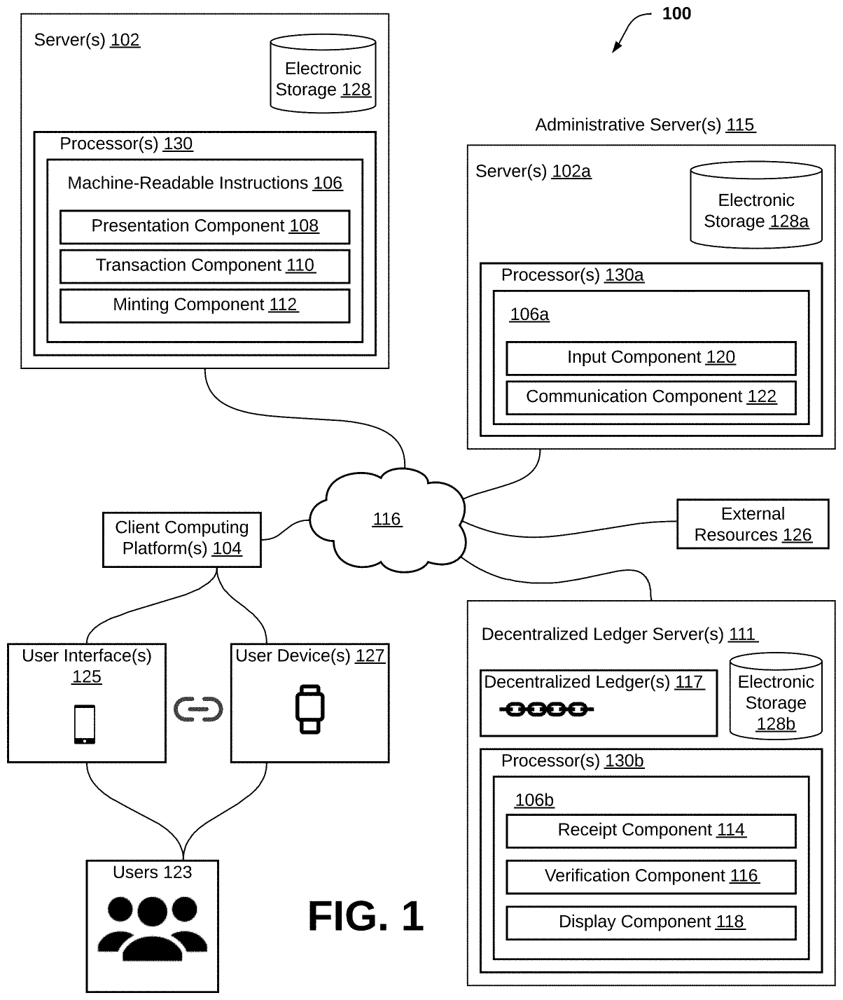

FIG. 1 illustrates a system 100 configured to create a customized digital content item and retrieve the digital content item to be displayed, in accordance with one or more implementations. As used herein, the term “digital content item” may refer to a customized digital content item selected and/or created by a user. As used herein “identifier” may refer to a digital content item identifier that is unique to a particular digital content item. For example, in some implementations, an identifier or identifying information of a digital content item may include or be based on a combination of different types of information, including but not limited to information regarding the type of digital content item, the digital features, the values of digital features, an alphanumeric string (e.g., a serial number or other text string) or other human and/or machine readable identifier of the digital content item, and/or other types of information. As used herein ownership of a digital content item may be tracked, recorded, and/or otherwise registered on one or more decentralized ledgers.

System 100 may include one or more server(s) 102, decentralized ledger server(s) 111, administration servers 115, one or more client computing platform(s) 104, user interface(s) 125, one or more external resources 126, and/or other components. As used in descriptions herein, any use of the term “user” may refer to users 123. Electronic storage 128a and electronic storage 128b may be similar to electronic storage 128 as described elsewhere in this disclosure, though included in administration server(s) 115 and decentralized ledger server(s) 111, respectively, as depicted in FIG. 1.

Decentralized ledger server(s) 111 may be used to implement one or more decentralized ledger(s) 117. In some implementations, decentralized ledger(s) 117 may be maintained by distributed computing platforms (not shown in FIG. 1). In some implementations, a distributed computing platform may be implemented by a set of client computing platforms and/or servers (including, for example, one or more decentralized ledger server(s) 111). The distributed computing platform may support a virtual machine (not shown in FIG. 1). The distributed computing platform and/or the virtual machine may form a runtime environment for smart contracts and/or other executable code. A distributed computing platform may include electronic storage configured to store part or all of decentralized ledger(s) 117. The smart contracts may be stored on decentralized ledger(s) 117 and/or another decentralized ledger. In some implementations, the distributed computing platform may be the EOSIO platform. In some implementations, the distributed computing platform may be similar to or based on the EOSIO platform. In some implementations, the distributed computing platform may be Ethereum. In some implementations, the distributed computing platform may be similar to or based on Ethereum. In some implementations, the virtual machine may be a decentralized virtual machine.

In some implementations, at least one of the decentralized ledger(s) 117 implemented by decentralized ledger server(s) 111 is a private permissioned decentralized ledger. The private permissioned blockchain may be configured to record information. The recorded information may pertain to one or more digital content items recorded on decentralized ledger(s) 117. The recorded information may include ownership of the digital content items. User actions may effectuate modifications to the recorded information pertaining to the digital content items. For example, ownership rights and/or other rights may be modified. In some implementations, a digital content item may be removed from one decentralized ledger and added or recorded on another decentralized ledger. In some implementations, at least one of the decentralized ledger(s) 117 implemented by decentralized ledger server(s) 111 is a public decentralized ledger. The public decentralized ledger may be configured to be part of either EOSIO mainnet, Ethereum mainnet, Ethereum 1.5, Ethereum 2.0, a derivative of Ethereum 2.0 that is configured to perform transactions of Ether (ETH) between accounts, or a derivative of EOSIO that is configured to perform transactions of EOS between different accounts.

Elements of decentralized ledger(s) 117 ledger may be grouped together in units that are referred to as blocks and/or nodes. For example, an individual block may include one or more assets (e.g., digital content items) and/or one or more transactions. For example, an individual block may be linked to one or more other individual blocks. Individual blocks may be linked or chained together to form a structure of blocks and/or a hierarchy of blocks, such as, e.g., a chain of blocks. An individual block may include one or more assets (e.g., digital content items), one or more transactions, and/or other information. As used herein, “an individual block including a digital content item” may refer to the individual block including a digital content item record and/or a digital content item identifier associated with the digital content item.

As depicted in FIG. 1, decentralized ledger server(s) 111 may include one or more of electronic storage 128b, processor(s) 130b, machine-readable instructions 106b, (node of) decentralized ledger(s) 117, and/or other components. Machine-readable instructions 106b may include one or more instruction components. The instruction components may include computer program components. The instruction components may include one or more of a receipt component 114, a verification component 116, a display component 118, and/or other instruction components. In some implementations, an individual decentralized ledger server(s) 111 may be dedicated to a particular node of a decentralized ledger(s) 117. Typically, different nodes are included in (or implemented by, or hosted by) different servers or different computer systems to increase the safety and security of transactions on a decentralized ledger and/or blockchain. The consensus protocol used for a particular blockchain will be harder to falsify or circumvent when the different nodes are in different geographical locations, on different types of computing platforms, and/or otherwise distributed and diverse.

In some implementations, one or more decentralized ledger(s) 117 implemented by decentralized ledger server(s) 111 may be publicly accessible. In some implementations, one or more decentralized ledgers implemented by decentralized ledger server(s) 111 may be private and/or permissioned. In some implementations, one or more decentralized ledger(s) 117 implemented by decentralized ledger server(s) 111 may be append-only. In some implementations, existing blocks and/or nodes of one or more decentralized ledger(s) 117 implemented by decentralized ledger server(s) 111 can substantially not be altered or deleted, unless multiple copies are altered. This is unlikely to happen provided that the multiple copies stored on different computing platforms, e.g., in different geographical locations, in accordance with the relevant consensus protocol(s). Decentralized ledger(s) 117 may be replicated on multiple computing platforms, preferably in multiple different geographical locations. Additionally, individual blocks and/or nodes may be linked together in a manner that prevents tampering, such as, e.g., using a hash chain and/or digital signatures. In particular, hash values may be generated using fixed-output-length one-way hashing functions that take variable-length input, and may be effectively impossible (or, at least, computationally infeasible) to reverse. As such, a hashing function may provide one-way encryption. By way of non-limiting example, the hashing function may be SHA-256, BLAKE2, SHAKE256, and/or another hashing function. Contents of individual blocks, individual nodes, transactions, and/or assets may be digitally signed in a manner that proves integrity and/or prevents tampering, e.g., by providing authentication, as well as repudiation.

Server(s) 102 may be configured to communicate with one or more client computing platforms 104 according to a client/server architecture and/or other architectures. Client computing platform(s) 104 may be configured to communicate with other client computing platform(s) 104 via server(s) 102 and/or according to a peer-to-peer architecture and/or other architectures. User(s) 123 may access system 100 via client computing platform(s) 104. In some implementations, system 100 and/or decentralized ledger server(s) 111 may be configured to communicate with one or more of server(s) 102, users 123, and/or other entities and/or components, e.g., through one or more network(s) 116. In some implementations, client computing platform(s) 104 may be accessed through one or more user interface(s) 125. User interface(s) 125 is shown as a mobile device but may include one or more other computing devices. User interface(s) 125 may be linked and/or associated to one or more user device(s) 127. User device(s) 127 may include a smartphone, a monitor, a head mounted device, a wearable device, a non-wearable device, a portable electronic device (e.g., personal digital assistance (PDA)), and/or other devices. User interface(s) 125 may be linked and/or associated to user device(s) 127 through wireless connection (e.g., Bluetooth pairing), wired connection, and/or other pairing methods.

Server(s) 102 may include electronic storage 128, processor(s) 130, machine-readable instructions 106, and/or other components. Server(s) 102 may be configured by machine-readable instructions 106. Machine-readable instructions 106 may include one or more instruction components. The instruction components may include computer program components. The instruction components may include one or more of a presentation component 108, a transaction component 110, a minting component 112, and/or other instruction components. Processor(s) 130a and processor(s) 130b may be similar to processor(s) 130 as described elsewhere in this disclosure, though included administration server(s) 115 and decentralized ledger server(s) 111, respectively, as depicted in FIG. 1. Machine-readable instructions 106a and machine-readable instructions 106b may be similar to machine-readable instructions 106 as described elsewhere in this disclosure, though included in administration server(s) 115 and decentralized ledger server(s) 111, respectively, as depicted in FIG. 1.

Presentation component 108 may be configured to effectuate presentation of a customization interface on one or more of client computing platform(s) 104 associated with a user 123. The customization interface may facilitate entry and/or selection of a digital content item design by user 123. The customization interface may display one or more types of digital content items that are selectable for the user. The one or more types of digital content items may include an object, an image, a video, a sound file, a text file, and/or other types of digital content items. The selection of one or more types of digital content items may define the type and/or file type of the digital content item that is generated. In some implementations, the customization interface may display base costs associated with the one or more types of digital content items. For example, a first base cost may be associated with generating a digital content item that is a video and a second base cost may be associated with generating a digital content item that is an image. The second base cost may be different than the first base cost.

The customization interface may display one or more digital features, values for individual ones of the digital features, and/or other information. The one or more digital features may be displayed with associated costs for including the digital features in the digital content item. The user may select one or more of the digital features to be included in the digital content item. In some implementations, the one or more digital features displayed in the customization interface may be determined by the type of digital content item selected by the user. For example, one or more digital features may be exclusive to a given type of digital content item. Digital features may include one or more of supplemental digital objects, images, texts, sounds, widgets (e.g., weather display, clock, etc.), backgrounds/backsplash, filters, and/or other components capable of being included in a digital content item. In some implementations, particular digital features may be static and/or unchanging. In some implementations, digital features may change based on one or more of the passage of time, real world events and/or real-time data (e.g. weather display), and/or other factors. For example, the backsplash of the digital content item may include a video, a gif, a slide show of images, and/or other moving and/or still images.

In some implementations, the customization interface may display the one or more values for digital features with an associated cost. A value for a digital feature may indicate and/or represent a variation of color, style, format, type, and/or other aspect of the digital features. For example, a first digital features may be a background and/or another digital feature. A first value may represent a first image for the background associated with a first cost and a second value may represent a second image for the background associated with a second cost. The first value, the second value, and/or other values for the background may be included in the customization interface and/or be capable of being selected by user 123. The associated cost for an individual value may be based on the popularity of the value, the remaining inventory of the value (i.e., the value can only be selected a fixed number of times and/or by a fixed number of users), the appearance of the value, and/or other information. In some implementations, the associated costs of the one or more values may change based on the popularity of the value, the remaining inventory of the value, the appearance of the value, and/or other information. The associated costs of the one or more values may change every day, every two days, every 12 hours, every 2 hours, every hour, and/or other intervals of time. In some implementations, the associated costs may be in units of dollars (USD), euros (EUR), Bitcoin (BTC), Ethereum (ETH), Tether (USDT), Dogecoin (DOGE), and/or other currencies.

In some implementations, the customization interface may display one or more pre-selected digital content item designs capable of being selected by user 123 for purchase. An individual digital content item design may be defined by one or more values of digital features. The digital content item design may represent the appearance of an associated digital content item. The pre-selected digital content item designs may include one or more values of digital features that are selected by other users 123, selected by one or more administrative users, randomly generated, and/or other methods of being selected. In some implementations, individual ones of the pre-selected digital content item designs may include an associated cost. The associated cost of a particular pre-selected digital content item designs may be based on the combined associated costs of the values of digital features included in the digital content item design. In some implementations, the associated costs of the particular pre-selected digital content item design may be set by a user that created the digital content item design. In some implementations, the user 123 may purchase a randomly generated digital content item design before viewing the digital content item design and/or after viewing the digital content item design. In some implementations, the particular digital content item design may only be selected (i.e., purchased) a fixed number of times. Responsive to the particular digital content item design being selected the fixed number of times, the particular digital content item design may be shown on the customization interface as having a sold-out status and/or not included in the customization interface.

Transaction component 110 may be configured to receive from client computing platform(s) 104, a mint request to mint the digital content item in accordance with the digital content item design entered and/or selected through the customization interface. In some implementations, the mint request may include information pertaining to the digital content item design, the user, and/or other information. Information pertaining to the digital content item design may include the values of digital content items features defining the digital content item design, the cost of the digital content item design, and/or other information. In some implementations, the mint request may be received from the client computing platform(s) 104 via one or more networks 116. The mint request may be automatically submitted to transaction component 110 responsive to user 123 selecting a digital content item design through the customization interface, user 123 selecting one or more action buttons on user interface(s) 125, user 123 initiating transfer of consideration, and/or other user actions.

Transaction component 110 may be configured to, responsive to receipt of the mint request, effectuate a transfer of consideration from a user wallet associated with the user to an administrative wallet and/or other wallets. The user wallet and the administrative wallet may each correspond to addresses on decentralized ledger(s) 117 such that the transfer of consideration involves a transfer of value on decentralized ledger(s) 117 from the address associated with the user wallet to the address associated with the administrative wallet. In some implementations, the amount of consideration and/or value may be determined by the cost of the digital content item design and/or the costs of the values of digital features defining the digital content item design. The amount of consideration and/or value may be included in the received mint request. The amount of consideration and/or value may further include a transfer fee, a transaction fee, a gas fee, and/or other types of fees in addition to the cost of the digital content item design.

In some implementations, the user wallet may be linked to an external wallet. The external wallet may allow the user to store and manage funds on a public decentralized ledger(s) 117. The public decentralized ledger(s) 117 may be part of either EOSIO mainnet, Ethereum mainnet, Ethereum 1.5, Ethereum 2.0, a derivative of Ethereum 2.0 that is configured to perform transactions of Ether (ETH) between accounts, a derivative of EOSIO that is configured to perform transactions of EOS between different accounts, and/or other distributed computing platforms. In some implementations, funds may be transferred from the linked external wallet to the user wallet. Funds transferred from the linked external wallet to the user wallet may be in units of dollars (USD), euros (EUR), Bitcoin (BTC), Ethereum (ETH), Tether (USDT), Dogecoin (DOGE), and/or other currencies. Transferring funds from the external wallet to the user wallet may include a transfer fee, a gas fee, and/or other kinds of fees. The funds transferred and/or stored in the user wallet may be used within system 100 (e.g., to buy a digital content item). In some implementations, the user wallet may store funds from transactions made within system 100 (e.g., from selling a digital content item). In some implementations, funds stored in the user wallet may only be used for transactions on decentralized ledger(s) 117 (e.g., buying, selling, or transferring digital content items). Funds stored in the user wallet may be transferred to the external wallet to be used for transactions on decentralized ledgers outside of system 100 (e.g., buying, selling, or transferring other digital and/or non-digital assets).

Minting component 112 may be configured to, responsive to the administrative wallet receiving the consideration, mint the digital content item. As used herein, the word “mint” may refer to performance, initiating, and/or execution of the process(es), transaction(s), procedure(s), operation(s), and/or step(s) that result in the instantiation of the digital content item, including the establishment of ownership, and definition of appearance of the digital content item. Minting the digital content item may include generating the digital content item record for the digital content item in accordance with the digital content item design. Minting the digital content item may further include transforming the digital content item design into a format that is readable by a device and/or other methods of creating a displayable digital content item. In some implementations, minting the digital content item may include building an executable program. The executable program to be transmitted to a device capable of executing the program. In some implementations, execution of the program by the device may display a digital content item with the values of digital features defining the digital content item design on a device of the device and/or other devices. In some implementations, the digital content item record may include the values of the digital features that define the digital content item design. In some implementations, the digital content item record may be recorded at an address on decentralized ledger(s) 117 in a smart contract and/or other executable code. The digital content item record may include information pertaining to the minted digital content item, including but not limited to the values of the digital features defining the digital content item design.

In some implementations, the digital content item record may include a digital content item identifier. The digital content item identifier may be unique to the minted digital content item. The identifier may include an alphanumeric string (e.g., a serial number or other text string) or other human and/or machine-readable identifier of the digital content item and/or other information. The identifier may be based on the values of digital features, the time the digital content item was minted, the day the digital content item was minted, and/or other information. For example, a first digital content item may have a first digital content item identifier of ‘001’, a second digital content item may have a second digital content item identifier of ‘002’, a third digital content item may have a third digital content item identifier of ‘003’, and so on and so forth. The first, second, third digital content item identifiers, and/or other identifiers may be determined based on the order in which the digital content items are minted. The first second, third digital content item identifiers and/or other digital content item identifiers may be unique, such that no two digital content item identifiers are the same. In some implementations, the first digital content item and the second digital content item may be minted in accordance with a first digital content item design and a second digital content item design, respectively. The first digital content item design and the second digital content item design may be defined by the same values of digital features (i.e., the first digital content item and the second digital content item have a similar or the same appearance). The first digital content item identifier and the second digital content item identifier may still have different numerical values. In some implementations, the digital content item identifier may indicate an owner history for the associated digital content item. For example, the digital content item identifier may include ownership information. Ownership information may indicate and/or identify a first owner, a second owner, a current owner, and/or other owners. By way of non-limiting example, the digital content item may have been owned by the first owner prior to being owned by the second owner. The digital content item may have been owned by the second owner prior to being owned by the current owner.

In some implementations, minting the digital content item may include burning the combination of values of digital features that define the digital content item design. As used herein, the word “burn” may refer to recordation of the values of digital features for an individual digital content item such that future minting of digital content items with identical values of some or all of the digital features are limited or even prohibited. Burning the combination of values may include making the combination of values unavailable for selection, unavailable for minting, and/or unavailable for other actions. For example, unavailable combinations of values may not be shown in the customization interface and/or the user may not be allowed to proceed with purchase of that digital content item. In some implementations, a combination of values may be burned after being minted once, after being minted five times, and/or after being minted a fixed number of times. In some implementations, a list of burned combinations may be stored in electronic storage 128, on decentralized ledger(s) 117, and/or other locations. The list of burned combinations may include information pertaining to the combinations of values of digital features that have been burned and/or are unavailable to be minted. In some implementations, minting component 112 receiving a mint request may effectuate a smart contract and/or other executable code to check the digital content item design included in the mint request against the list of burned combinations. Responsive to the digital content item design being on the list of burned combinations, the mint request may not be fulfilled. Responsive to the digital content item design not being on the list of burned combinations, the mint request may be fulfilled and/or a digital content item may be minted in accordance with the digital content item design.

Minting component 112 may be configured to transfer a non-fungible token indicating the digital content item identifier to the address on the decentralized ledger(s) 117 that corresponds to the user wallet. In some implementations, the non-fungible token may be transferred simultaneously to the digital content item record being generated. In some implementations, transferring the non-fungible token may instruct the formation of a smart contract and/or the recording of the smart contract on decentralized ledger(s) 117 at the address corresponding to the user wallet. In some implementations, these instructions may instruct decentralized ledger(s) 117 to record and/or modify digital content item records, transactions, and/or rights (e.g., ownership rights, distributions rights, etc.). In some implementations, the non-fungible token may be stored on a blockchain. The block chain may implement decentralized ledger(s) 117 and may be capable of recording rights pertaining to digital assets (e.g., digital content items). For example, a blockchain is a type of ledger, as well as a type of decentralized database that records rights pertaining to digital assets. Multiple rights may form a set of rights or a bundle of rights that may be transferred and/or otherwise acted on and/or operated on together. For example, rights may include one or more of a right to use, a right to sell, a right to destroy, a right to certain types of distributions, and/or other rights. In some implementations, the non-fungible tokens may be a type of asset. In some implementations, the non-fungible tokens may include one or more of security tokens, utility tokens, payment tokens, initial coin offering (ICO) tokens, virtual currency tokens, crypto tokens, ERC-20 tokens, ERC-721 tokens, EOS tokens, specialized tokens, platform tokens, and/or other tokens. In some implementations, the tokens not only represent value, but may have a specific use in a particular distributed computing platform, e.g., in the operation of decentralized ledger(s) 117.

Receipt component 114 may be configured to receive a display request to display the digital content item on a device. The display request may indicate user(s) 123 trying and/or wanting to display the digital content item on the device. In some implementations, user 123 may submit a display request through interacting with one or more user interface(s) 125, interacting with one or more devices with user device(s) 127, and/or other ways. The display request may indicate the specific digital content item (e.g., using the digital content item identifier), a user associated with the device, a user wallet associated with the user, an address on decentralized ledger(s) 117 associated with the user wallet, and/or other information.

Verification component 116 may be configured to, responsive to receiving the display request, determine whether the user wallet for a decentralized ledger(s) 117 holds a non-fungible token associated with the specific digital content item. In some implementations, determining whether the user wallet holds a non-fungible token may include determining if the non-fungible token is recorded at the address associated with the user wallet on decentralized ledger(s) 117. In some implementations, the address associated with the user wallet may hold one or more tokens (i.e., the user owns one or more digital content items). The non-fungible token may be recorded on a smart contract and/or other executable code. Responsive to the non-fungible token being recorded at the address associated with the user wallet on decentralized ledger(s) 117, determine if the non-fungible token indicates the digital content item identifier associated with the digital content item. In some implementations, the digital content item identifier may be included in the display request. Responsive to the non-fungible token indicating the digital content item identifier associated with the digital content item, a determination may be made that the user has ownership of the digital content item. Responsive to the non-fungible token not indicating the digital content item identifier associated with the digital content item, a determination may be made that the user does not have ownership of the digital content item. In some implementations, verification component 116 may be configured to obtain digital content item rights (e.g., ownership rights, distribution rights, licensing rights, and/or other rights) for a particular digital content item, responsive to the user having ownership of the particular digital content item. In some implementations, verification component 116 may be configured to access decentralized ledger(s) 117 to obtain the digital content item rights (that are recorded on decentralized ledger(s) 117, e.g., in one or more smart contracts).

Display component 118 may be configured to, responsive to the user wallet holding the non-fungible token associated with the digital content item, facilitating display of the digital content item on the device. Facilitating display of the digital content item may include initiating transmission of information to the device that causes the device to display the digital content item. In some implementations, information may include the digital content item design, the values of digital features, the executable program, other executable code, and/or other information. In some implementations, the device may be associates to user 123 and/or associated to the user wallet. Display component 118 may be further configured to, responsive to the user wallet not holding the non-fungible token associated with the digital content item, take no further action to facilitate display of the digital content item on the device such that the digital content item is not displayed on the device

Input component 120 may be configured to receive user input from administrative users. For example, the user input may include entry and/or selection of particular information, digital content item design, values of digital features, digital content items, and/or any entity or object that interacts with any part of system 100 and/or plays a part in the operation of system 100. For example, an administrative user may select a particular set of digital content item designs and/or values of digital features as the input for other components of system 100, such as presentation component 108. Additionally, the administrative user may select a particular adjustment to be displayed by presentation component 108 (e.g., increase the cost of one or more values of digital features).

Communication component 122 may be configured to facilitate communication and/or interaction between administration server 115 and the rest of system 100. For example, communication component 122 may communicate user input received by input component 120 to other components of system 100.

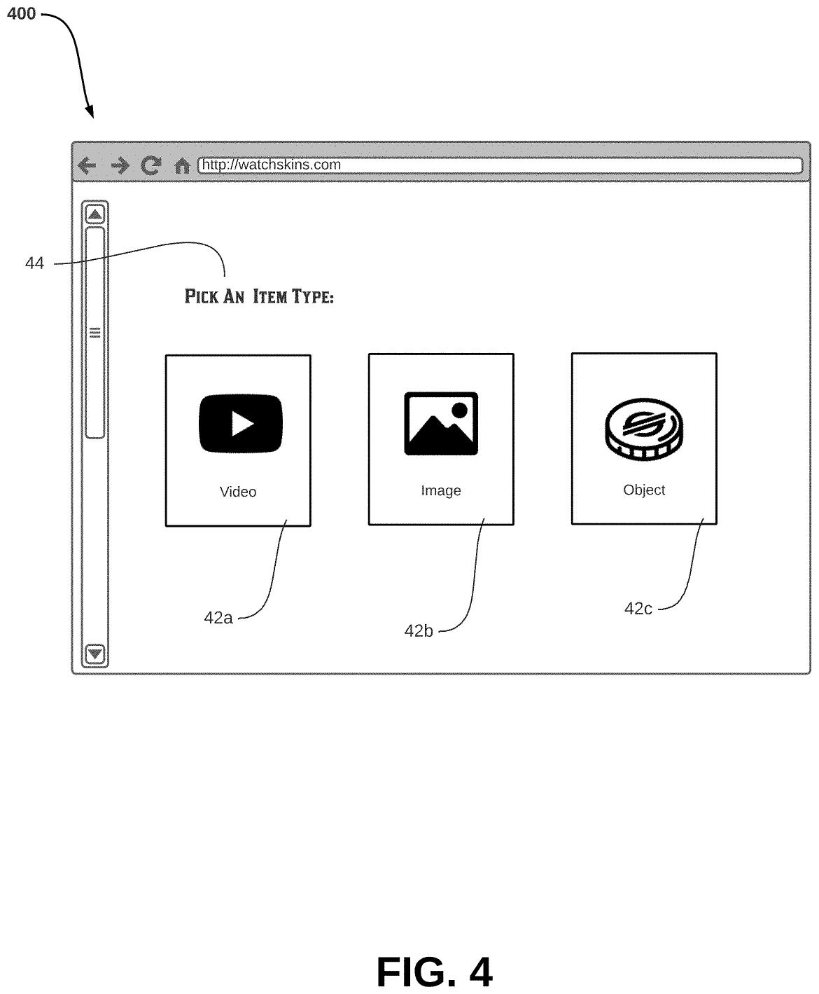

FIG. 4 illustrates an exemplary customization interface 400 that may be used by a system to create a customized digital content item and retrieve the digital content item to be displayed in accordance with one or more implementations. In some implementations customization interface 400 may be presented on a user interface that is the same as or similar to user interface(s) 125 (as shown in FIG. 1 and described herein). In some implementations, a user may view customization interface 400 through a web browser, a mobile browser, a mobile application, and/or other platforms. In some implementations, the user may be required to create and/or login to a user account associated with the user to access customization interface 400. The user account may be specific to a distributed computing platform and/or system 100 (as shown in FIG. 1 and described herein). The user account associated with the user may also be associated with a user wallet. In some implementations, the user account and/or user wallet may store a user's inventory. The user's inventory may include one or more digital content items the user has purchased and/or currently owns (i.e., the user wallet holds a non-fungible token indicating the digital content identifier associated with the digital content item). In some implementations, the user account may be used to store association to one or more devices capable of display a digital content item. The one or more devices associated to the user account may be capable of displaying one or more digital content items owned by the user.

Referring to FIG. 4, customization interface 400 may include a prompt 44, one or more user interface elements 42a-c representing types of digital content items and/or other components. The one or more types of digital content items may be capable of being selected by the user for the customized digital content item. The one or more types of digital content items may include type 42a indicating a video digital content item, type 42b indicating an image digital content item, and/or type 42c indicating an object digital content item. It should be noted that the types are shown for illustrative purposes and are not intended to be limiting. Customization interface 400 may include more or less types of digital content items and/or different types of digital content items than those shown.

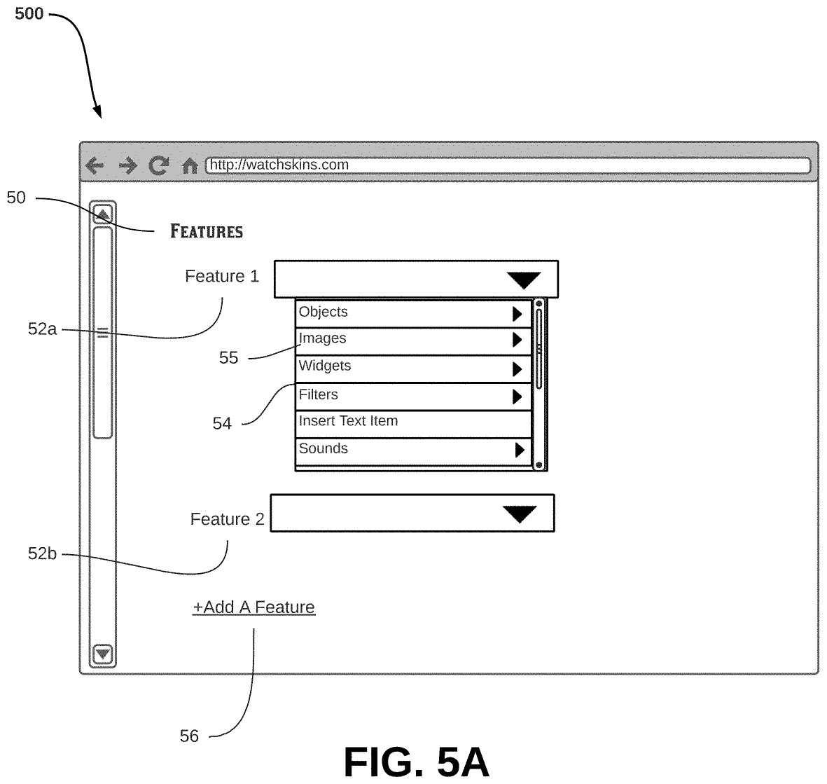

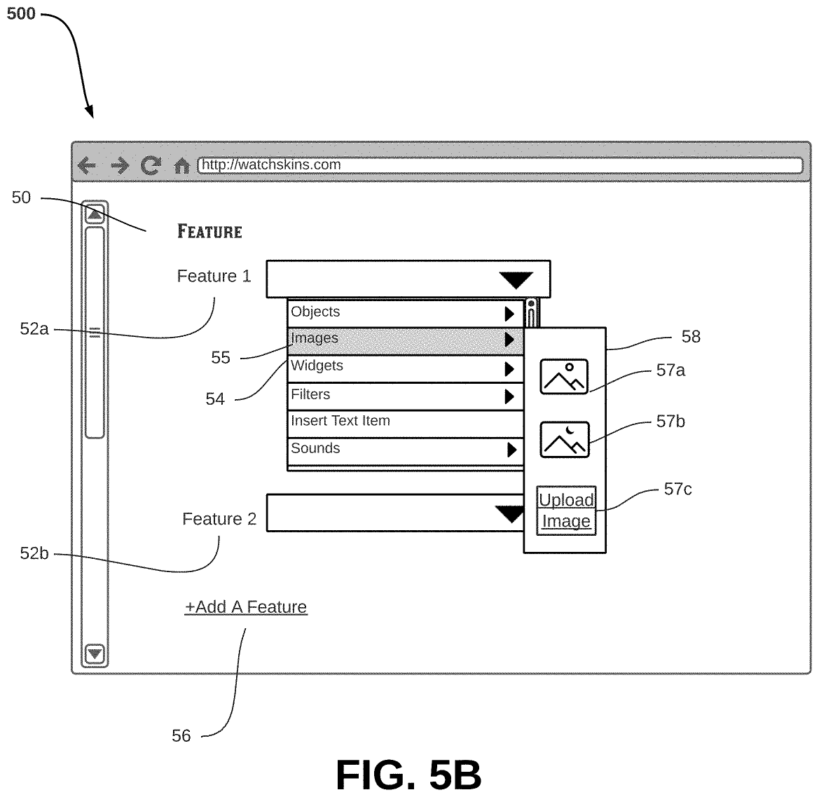

FIG. 5A shows customization interface 500 may include one or more fields 52a-b for selecting a type of digital features, one or more user interface elements 56, and/or other components. The one or more fields 52a-b may include a dropdown menu 54 and/or other user interface elements configured to display one or more types of digital features. The one or more types of digital features may be selectable by the user. Selection of the one or more types of digital features may effectuate the selected digital features to be included in the digital content item. For example, “Feature 1” may be one or more of an object, image, widget, filter, text item, sound, and/or other digital component capable of being included in the digital content item. In some implementations, the one or more types of digital features displayed in customization interface 500 may be determined by the type of digital content item selected (e.g., from user interface 400 shown in FIG. 4). User interface element 56 may be capable of being selected by the user to add a digital feature to the customized digital content item. In some implementations, selection of user interface element 56 may effectuate display of a field for selecting a type of digital feature (similar to fields 52a-b).

FIG. 5B shows customization interface 500 responsive to selection by the user of type of digital feature 55 (shown as “Images”) including selection menu 58 and/or other components. Selection menu 58 may display one or more user interface elements 57a-c representing one or more values for the type of digital feature 55. In some implementations, the values displayed in the selection menu may be determined by the type of digital feature selected. For example, the values displayed for “Images” may be different from the values for “Widgets”. Individual ones of values may be selectable the user. Selection of one or more values 57a-c may effectuate inclusion of the digital feature having the selected value to be included in the digital content item. In some implementations, a user interface elements 57c may prompt the user to upload one or more files and/or other content to be included in the digital content item.

In some implementations, selection of a particular value may include clicking, touching, tapping, and/or swiping an action button associated with the value and/or other actions. In some implementations, the user may select values for one or more digital features prior to submitting a mint request. In some implementations, digital features for which the user does not select a value may be randomly selected by the system during minting of the digital content item.

Referring to FIG. 1, user interface(s) 125 may be configured to facilitate interaction between users 123 and system 100 and/or between users 123 and client computing platform(s) 104. In some implementations, user interface(s) 125 may include one or more of a display screen, touchscreen, monitor, a keyboard, buttons, switches, knobs, levers, mouse, microphones, sensors to capture voice commands, sensors to capture body movement, sensors to capture hand and/or finger gestures, and/or other user interface devices configured to receive and/or convey user input. In some implementations, one or more user interface(s) 125 may be included in one or more client computing platform(s) 104. In some implementations, one or more user interfaces 125 may be included in system 100. In some implementations, user interface(s) 125 may be a type of interface that facilitates the exchange of virtual items between users.

Referring to FIG. 1, in some implementations, server(s) 102, client computing platform(s) 104, administration server(s) 115, decentralized ledger server(s) 111, and/or external resources 126 may be operatively linked via one or more electronic communication links. For example, such electronic communication links may be established, at least in part, via one or more network(s) 116 such as the Internet and/or other networks. It will be appreciated that this is not intended to be limiting, and that the scope of this disclosure includes implementations in which server(s) 102, client computing platform(s) 104, administration server(s) 115, decentralized ledger server(s) 111, and/or external resources 126 may be operatively linked via some other communication media.

A given client computing platform 104 may include one or more processors configured to execute computer program components. The computer program components may be configured to enable an expert or user associated with the given client computing platform(s) 104 to interface with system 100 and/or external resources 126, and/or provide other functionality attributed herein to client computing platform(s) 104. By way of non-limiting example, the given client computing platform(s) 104 may include one or more of a desktop computer, a laptop computer, a handheld computer, a tablet computing platform, a NetBook, a Smartphone, a gaming console, and/or other computing platforms.

Administration server(s) 115 may include one or more of server(s) 102a, processor(s) 130a, machine-readable instructions 106a, electronic storage 128a, and/or other components. Server(s) 102a may be configured by machine-readable instructions 106a. Machine-readable instructions 106a may include one or more instruction components. The instruction components may include one or more of input component 120, communication component 122, and/or other instruction components. Administration server(s) 115 may include communication lines, or ports to enable the exchange of information with a network and/or other computing platforms. In some implementations, administration server(s) 115 may be used by one or more administrative users, e.g., to configure and/or control operation of system 100. In some implementations, administrative server(s) 115 may include or user one or more user interfaces to receive user input and/or otherwise interact with one or more administrative users. In some implementations, the one or more administrative user may be able to modify the associated costs of the values of digital features, the cost of pre-selected digital content item designs, and/or make other modifications. In some implementations, the one or more administrative users may be able to make transactions of consideration and/or value from and/or to the administrative wallet.

External resources 126 may include sources of information outside of system 100, external entities participating with system 100, external providers of computation and/or storage services, and/or other resources. In some implementations, some or all of the functionality attributed herein to external resources 126 may be provided by resources included in system 100. In some implementations, external resources 126 may include one or more blockchain oracles.

Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, 118, 120, and/or 122, and/or other components. Processor(s) 130 may be configured to execute components 108, 110, 112, 114, 116, 118, 120, and/or 122, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, and/or 122 are illustrated in FIG. 1 as being implemented within a single processing unit, in implementations in which processor(s) 130 includes multiple processing units, one or more of components 108, 110, 112, 114, 116, 118, 120, and/or 122 may be implemented remotely from the other components. The description of the functionality provided by the different components 108, 110, 112, 114, 116, 118, 120, and/or 122 described below is for illustrative purposes, and is not intended to be limiting, as any of components 108, 110, 112, 114, 116, 118, 120, and/or 122 may provide more or less functionality than is described. For example, one or more of components 108, 110, 112, 114, 116, 118, 120, and/or 122 may be eliminated, and some or all of its functionality may be provided by other ones of components 108, 110, 112, 114, 116, 118, 120, and/or 122. As another example, processor(s) 130 may be configured to execute one or more additional components that may perform some or all of the functionality attributed below to one of components 108, 110, 112, 114, 116, 118, 120, and/or 122.

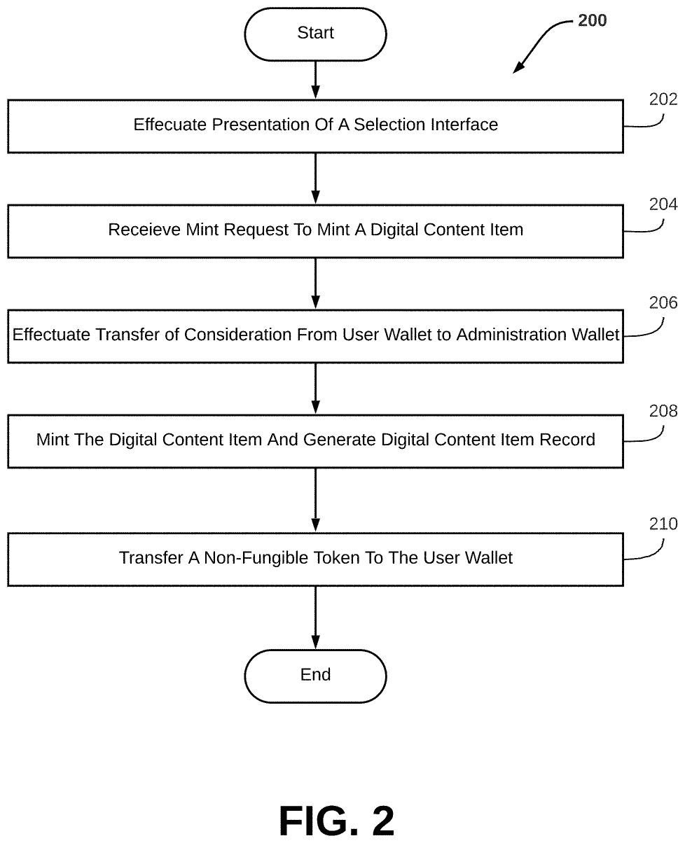

FIG. 2 illustrates a method 200 to create a customized digital content item, in accordance with one or more implementations. The customized digital content item may be recorded on a decentralized ledger. The customized digital content item may be capable of being displayed on a device. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include effectuating presentation of a customization interface on a client computing platform associated with a user. The customization interface may facilitate entry and/or selection of a digital content item design by the user. The digital content item design may be defined by values of digital features. Operation 202 may be performed by a presentation component that is same as or similar to presentation component 108 (shown in FIG. 1 and described herein).

An operation 204 may include receiving, from the client computing platform, a mint request to mint the digital content item in accordance with the digital content item design entered and/or selected through the customization interface. Operation 204 may be performed by a transaction component that is same as or similar to transaction component 110 (shown in FIG. 1 and described herein).

An operation 206 may include effectuating, responsive to receipt of the mint request, a transfer of consideration from a user wallet associated with the user to an administrative wallet. The user wallet and the administrative wallet may each correspond to addresses on the decentralized ledger such that the transfer of consideration involves a transfer of value on the decentralized ledger from the address associated with the user wallet to the address associated with the administrative wallet. Operation 206 may be performed by a transaction component that is same as or similar to transaction component 110 (shown in FIG. 1 and described herein).

An operation 208 may include, responsive to the administrative wallet receiving the consideration, minting the digital content item. Minting the digital content item may include generating a digital content item record for the digital content item in accordance with the digital content item design. The digital content item record may include the values of the digital features that define the digital content item design. The digital content item record may include a digital content item identifier. Operation 208 may be performed by a minting component that is same as or similar to minting component 112 (shown in FIG. 1 and described herein).

An operating 210 may include transferring a non-fungible token indicating the digital content item identifier to the address on the decentralized ledger that corresponds to the user wallet. Operation 210 may be performed by a minting component that is same as or similar to minting component 112 (shown in FIG. 1 and described herein).

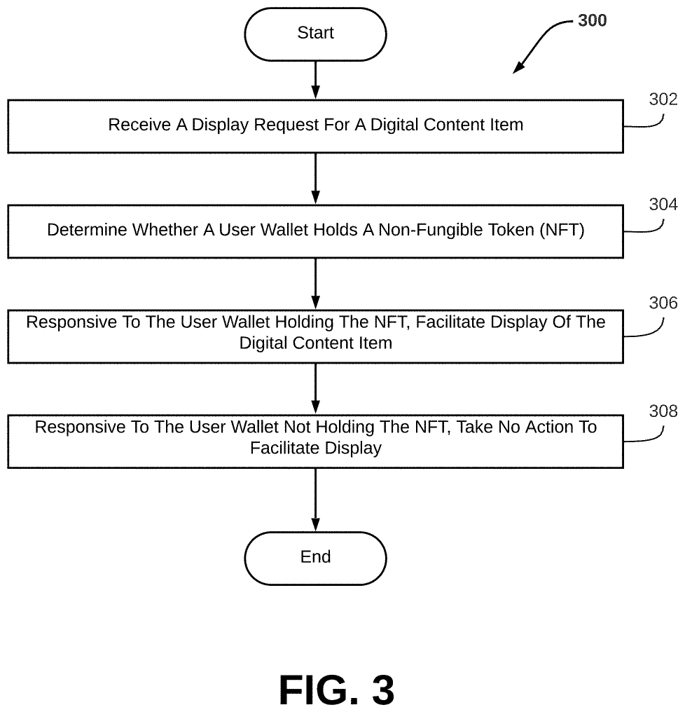

FIG. 3 illustrates a method 300 to retrieve a digital content item to be displayed on a device, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving a display request to display the digital content item on a device. The display request may indicate the specific digital content item, a user associated with the device, and/or other information. Operation 302 may be performed by a receipt component that is same as or similar to receipt component 114 (shown in FIG. 1 and described herein).

An operation 304 may include, responsive to receiving the display request, determining whether a user wallet for a decentralized ledger holds a non-fungible token associated with the specific digital content item. The user wallet being associated with the user. Operation 304 may be performed by a verification component that is same as or similar to verification component 116 (shown in FIG. 1 and described herein).

An operation 306 may include, responsive to the user wallet holding the non-fungible token associated with the digital content item, facilitating display of the digital content item on the device. Facilitating display of the digital content item may include initiating transmission of information to the device that causes the device to display the digital content item. Operation 306 may be performed by a display component that is same as or similar to display component 118 (shown in FIG. 1 and described herein).

An operation 308 may include, responsive to the user wallet not holding the non-fungible token associated with the digital content item, taking no further action to facilitate display of the digital content item on the device such that the digital content item is not displayed on the device. Operation 308 may be performed by a display component that is same as or similar to display component 118 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. It is to be understood that the present technology contemplates that, to the extent possible, one or more features of any implementation can be combined with features of any other implementation.

1. A system configured to create a customized digital content item, wherein ownership of the customized digital content item is recorded on a decentralized ledger, wherein the digital content item is formatted to be streamed or displayed, the system comprising:
one or more processors configured by machine-reachable instructions to:
effectuate presentation of a customization interface on a client computing platform associated with a user, wherein the customization interface facilitates entry and/or selection of a digital content item design by the user, and wherein the digital content item design is defined by values of digital features;
receive, from the client computing platform, a mint request to mint the digital content item in accordance with the digital content item design entered and/or selected through the customization interface;
responsive to receipt of the mint request, effectuate a transfer of consideration from a user wallet associated with the user to an administrative wallet, wherein the user wallet and the administrative wallet each correspond to addresses on the decentralized ledger such that the transfer of consideration involves a transfer of value on the decentralized ledger from the address associated with the user wallet to the address associated with the administrative wallet; and
responsive to the administrative wallet receiving the consideration:
(i) mint the digital content item, wherein minting the digital content item includes generating a digital content item record for the digital content item in accordance with the digital content item design, wherein the digital content item record includes the values of the digital content item features that define the digital content item design, and wherein the digital content item record includes a digital content item identifier, and
(ii) transfer a non-fungible token indicating the digital content item identifier to the address on the decentralized ledger that corresponds to the user wallet.

2. The system of claim 1, wherein generating a digital content item record for the digital content item further includes burning the digital content item design, such that a second digital content item cannot be minted in accordance with the digital content item design.

3. The system of claim 1, wherein digital content item is an image, a video, or an audio.

4. The system of claim 1, wherein the digital content item features include size, background, background color, one or more objects, movement of objects, color of objects, sound, lighting, captions, and filters.

5. The system of claim 1, wherein the customization interface displays associated costs for individual ones of the values of digital content item features, and wherein the cost of the digital content item design is based on the combined associated costs of the values of digital content item features that define the digital content item design.

6. The system of claim 1, wherein the values of digital content item features defining the digital content item design may be randomly generated by the system, such that the digital content item is minted and the digital content item record is generated in accordance with the randomly generated digital content item design.

7. (canceled)

8. (canceled)

9. (canceled)

10. (canceled)

11. A method to create a customized digital content item, wherein ownership of the customized digital content item is recorded on a decentralized ledger, wherein the digital content item is formatted to be streamed or displayed, the method comprising:
effectuating presentation of a customization interface on a client computing platform associated with a user, wherein the customization interface facilitates entry and/or selection of a digital content item design by the user, and wherein the digital content item design is defined by values of digital features;
receiving, from the client computing platform, a mint request to mint the digital content item in accordance with the digital content item design entered and/or selected through the customization interface;
responsive to receiving the mint request, effectuating a transfer of consideration from a user wallet associated with the user to an administrative wallet, wherein the user wallet and the administrative wallet each correspond to addresses on the decentralized ledger such that the transfer of consideration involves a transfer of value on the decentralized ledger from the address associated with the user wallet to the address associated with the administrative wallet; and
responsive to the administrative wallet receiving the consideration:
(i) minting the digital content item, wherein minting the digital content item includes generating a digital content item record for the digital content item in accordance with the digital content item design, wherein the digital content item record includes the values of the digital content item features that define the digital content item design, and wherein the digital content item record includes a digital content item identifier, and
(ii) transferring a non-fungible token indicating the digital content item identifier to the address on the decentralized ledger that corresponds to the user wallet.

12. The method of claim 11, wherein generating a digital content item record for the digital content item further includes burning the digital content item design, such that a second digital content item cannot be minted in accordance with the digital content item design.

13. The method of claim 11, wherein digital content item is an image, a video, or an audio.

14. The method of claim 11, wherein the digital content item features include size, background, background color, one or more objects, movement of objects, color of objects, sound, lighting, captions, and filters.

15. The method of claim 11, wherein the customization interface displays associated costs for individual ones of the values of digital content item features, and wherein the cost of the digital content item design is based on the combined associated costs of the values of digital content item features that define the digital content item design.

16. The method of claim 11, wherein the values of digital content item features defining the digital content item design may be randomly generated by the system, such that the digital content item is minted and the digital content item record is generated in accordance with the randomly generated digital content item design.

17. (canceled)

18. (canceled)

19. (canceled)

20. (canceled)
